(19) United States
(12) Patent Application Publication
(10) Pub. No.: US 2007/0040682 A1
(43) Pub. Date: Feb. 22, 2007

(54) RFID inventory control system

(75) Inventors: Jeffrey Zhu, Richmond Hill (CA); Roger Tong, Oakville (CA)

Correspondence Address: CONLEY ROSE, P.C., P. O. BOX 3267, HOUSTON, TX, 77253-3267, US

(73) Assignee: Mark IV Industries Corp., Mississauga (CA)

(21) Appl. No.: 11/209,020

(22) Filed: Aug. 22, 2005

(51) Int. Cl. G08B 13/14

(52) U.S. Cl. 340/572.1; 340/10.1; 340/5.92; 340/5.8

(57) ABSTRACT

A method and system for tracking a plurality of items, wherein the items are individually equipped with item tags. The method and system provides for an integrity tag or memory element associated with the plurality of items, for example, within a container. The integrity tag stores data regarding the plurality of items, permitting a reader to verify the integrity of the information received from an interrogation of the plurality of item tags. For example, in one embodiment the integrity tag provides a count of the number of items in the container or an error detection value. The reader may then verify that it has received responses from the correct number of item tags in order to verify that the correct number of items are present in the container.

### FIELD OF THE INVENTION

The present invention relates to inventory control systems and, in particular, to a radio frequency identification (RFID) based inventory control system incorporating an intermediate or summary transponder.

### BACKGROUND OF THE INVENTION

Radio frequency identification technology is now being used to track a wide variety of items. In fact, Electronic Product Code (EPC) represents a set of standards developed for item identification across a full spectrum of industries and applications. The basic concept is that all items are fitted with an RFID tag that encodes the item's unique EPC. The item may then be tracked and identified with the use of readers that communicate with the tag and receive EPC information from the tag.

In some circumstances, there may be a plurality of items in a container, such in the context of shipping, packaging, or storage. For example, a carton of consumer goods may contain tens, hundreds, even thousands of items all individually equipped with RFID tags. In these circumstances, it is difficult to know if all the tags have been read correctly or if any of the items are missing. A common problem and source of loss in many industries is theft or damage during transport.

Another problem is that the reader does not know whether it has read all of the tags that are present in the container. One or more of the tags present in the container may have failed to transmit, whether because of RF interference, unresolved collisions, or other factors.

It would be advantageous to provide for an RFID inventory control system that improves upon the tagging of individual items with EPC codes.

### SUMMARY OF THE INVENTION

The present invention provides a method and system for tracking a plurality of items, wherein the items are individually equipped with item tags. The method and system provides for an integrity tag associated with the plurality of items, for example, within a container. The integrity tag stores data regarding the plurality of items, permitting a reader to verify the integrity of the information received from an interrogation of the plurality of item tags. For example, in one embodiment the integrity tag provides a count of the number of items in the container. The reader may then verify that it has received responses from the correct number of item tags in order to verify that the correct number of items are present in the container.

In one aspect, the present invention provides a system for inventory control using radio frequency identification (RFID). The system is for tracking a plurality of items. The system includes a plurality of item tags, each item tag being associated with one of the plurality of items and storing item information. It also includes an integrity memory element associated with the plurality of items and storing information regarding the plurality of item tags, and a reader for interrogating the plurality of item tags and for reading the integrity memory element, so as to permit verification of the item information.

In another aspect, the present invention provides a container for holding a plurality of items. Each of the items has an associated item tag, which is readable by a reader employing RFID communication. The container includes sidewalls and an integrity tag. The integrity tag includes an antenna, a controller, a modulator, and a memory. The memory stores integrity data for transmission to the reader in response to reception of an interrogation signal. The integrity data includes data regarding the plurality of item tags.

In yet another aspect, the present invention provides a method of verifying information regarding a plurality of items. Each of the items has an associated item tag each storing item data. The plurality of items have an associated integrity memory element that stores integrity data regarding the plurality of items. The method includes steps of interrogating the plurality of item tags using a reader, receiving the item data from each item tag and reading the integrity data from the integrity memory element. The integrity data includes a check value. The method also includes steps of determining a variable based upon the item data received from the item tags, and comparing the variable with the check value received from the integrity memory element to verify the integrity of the plurality of items.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 shows an embodiment of an RFID-based inventory control system in block diagram form;

FIG. 2 shows, in block diagram form, an embodiment of an integrity tag for use in an RFID-based inventory control system;

FIG. 3(a) shows a cross-sectional view of a wall of a cardboard container having an integrity tag attached;

FIG. 3(b) shows a cross-sectional view of a wall of a molded container having an integrity tag embedded;

FIG. 4 shows, in flowchart form, a method of tracking items in a container using an integrity tag; and

FIG. 5 shows, in block diagram form, an embodiment of an integrity tag having reader capabilities.

Similar reference numerals are used in different figures to denote similar components.

### DESCRIPTION OF SPECIFIC EMBODIMENTS

Although some of the embodiments described below refer to a plurality of items being contained with “a container”, it will be appreciated that the present application is not limited to embodiments involving a “container”. In some cases items may be stored or shipped on pallets or without any physical structure for co-locating the items. For example, a group of larger items, like appliances, may not have any physical “container” or boundary associated with them, yet they may form a “plurality of items”, as that term is used herein.

Reference is first made to FIG. 1, which shows an embodiment of an RFID inventory control system 10. The system 10 includes a reader 12 and a plurality of item tags 14. The reader 12 is configured to interrogate and read item information from each of the item tags 14. The item tags 14 are each associated with or attached to an item 18. The items 18 may be, for example, consumer products such as individual articles of clothing, accessories, household items, etc. More generally, the items 18 may be any product or article that may be labeled with an EPC tag. Even more generally, the items 18 may be any articles or items that may be made the subject of inventory control.

The items 18 are collected within a container 20. In one embodiment, the container 20 is a cardboard or plastic box for holding and/or transporting the items 18; however, the container 20 is not so limited. In other embodiments, the container 20 may comprise a large shipping container, a pallet, a railcar, a transport trailer, or other device or container that may contain or be associated with a number of items or articles for packaging, transportation or storage.

Each individual item tag 14 stores information regarding its associated item 18. The item information stored in the item tag 14 may include identifying information regarding the class of the item 18, its product name or number, a serial number, a manufacturer, shipping date(s), best-before date, or any other data regarding the item 18.

In many embodiments, the item tags 14 are passive devices that use backscatter modulation to communicate with the reader 12. In some embodiments, the item tags 14 may be active devices having integrated power sources, such as a battery, for transmitting RF signals to the reader 12.

The reader 12 interrogates the item tags 14 and the item tags 14 respond by transmitting the stored item information to the reader 12. The configuration of the reader 12 and the item tags 14 and the protocols for engaging in interrogation and response are well known in the art. In one embodiment, the item tags 14 include EPC information, as described in Auto-ID Center publication Draft Protocol Specification for a 900 MHz Class 0 RFID, Feb. 23, 2003, the contents of which are incorporated herein by reference. Anti-collision mechanisms may be employed to enable the reader 12 to read the item information from each of the item tags 14 in the container 20.

The system 10 further includes an integrity tag 16 associated with the plurality of items 18. The integrity tag 16 includes a memory that stores information regarding the plurality of item tags 14 and/or the plurality of items 18. The information stored by the integrity tag 16 may be used to verify the integrity of the container 20 and its cargo of items 18. The reader 12 interrogates the integrity tag 16 and the integrity tag 16 provides the reader 12 with the stored integrity information. This information may then be compared to information obtained from the individual item tags 14.

Although the presently described embodiment includes an RFID-based integrity tag 16, in other embodiments non-RFID integrity memory elements may be employed to store information regarding the plurality of item tags 14 and/or the plurality of items 18. For example, the integrity memory element may comprise a readable digital memory, such as a memory stick or contact memory device. In some embodiments, the integrity memory element may comprise a non-digital element, such as a printed barcode label. The barcode may be applied to a container, shipping bill, or other location associated with the plurality of items 18. Regardless of whether the information is stored or encoded in a digital memory, barcode, or other storage mechanism, the integrity memory element is to be readable by an electronic reader, like an RFID reader or barcode reader, so as to obtain the information.

It will also be appreciated that the integrity tag 16 may include more than one RFID element. For example, when using off-the-shelf RFID tags, the memory capacity of a single tag may be insufficient for serving as the integrity tag 16 in a particular embodiment. In such a case, the integrity tag 16 may comprise more than one RFID tag.

Referring still to FIG. 1, when the container 20 is loaded with the items 18 and their associated item tags 14, the reader 12 may program the integrity tag 16 with information regarding the items 18 and items tags 14 in the container 20. For example, it may store information in the integrity tag 16 regarding the number of items 18. Once the items 18 are loaded into the container 20, the reader 12 may interrogate the item tags 14 and thereby obtain a count of the number of items 18. This number may then be stored within the integrity tag 16. Upon arrival at an intended destination, the receiving party may use another reader 12 to interrogate the item tags 14 and the integrity tag 16 to identify and verify the contents of the container 20.

By way of example, the integrity tag 16 may store an item count value representing the number of items 18 that should be present in the container 20. A reader 12 may interrogate the item tags 14 and thereby obtain a count of the number of items 18 in the container 20. By comparing this count with the item count value read from the integrity tag 16, the reader 12 may identify if there are items 18 missing from the container 20.

In another example, the integrity tag 16 may store information regarding the specific items 18 in the container 20. For example, it may store the specific serial numbers of the items 18 in the container 20, or the range of serial numbers for the items 18 in the container 20. Based upon this information, the reader 12 may determine which specific item 18 is missing, as identified by its serial number.

In yet another example, the integrity tag 16 may store checksum or check-return-code (CRC) information based upon, for example, address information for all the item tags. In the event that, for example, a sum of item tag addresses does not match the checksum value stored in the integrity tag 16 it will be apparent that one or more of the addresses is incorrect or is missing. Other error detection schemes may also be employed.

In some embodiments, the reader 12 may be capable of determining if one of the item tags 14 has been mis-programmed, i.e. that it contains faulty information. For example, the reader 12 may be able to determine whether it has received incorrect information from one of the item tags 14. The faulty information may be detected using forward error correction, checksum, or other error detection schemes or algorithms. Upon detecting the faulty information, the reader 12 may re-interrogate the item tag 14 to ensure it obtained the right information. If the information returned by the item tag 14 is again faulty, then the reader 12 may communicate with a back office database or other source to determine the correct information and reprogram the tag. In some cases, it may be capable of determining the correct information through appropriate calculations, for example from a checksum value. It will be appreciated that a security protocol may be imposed to prevent the reader 12 from reprogramming any item tags 14 without authorization from a back office system so as to ensure the integrity of the system.

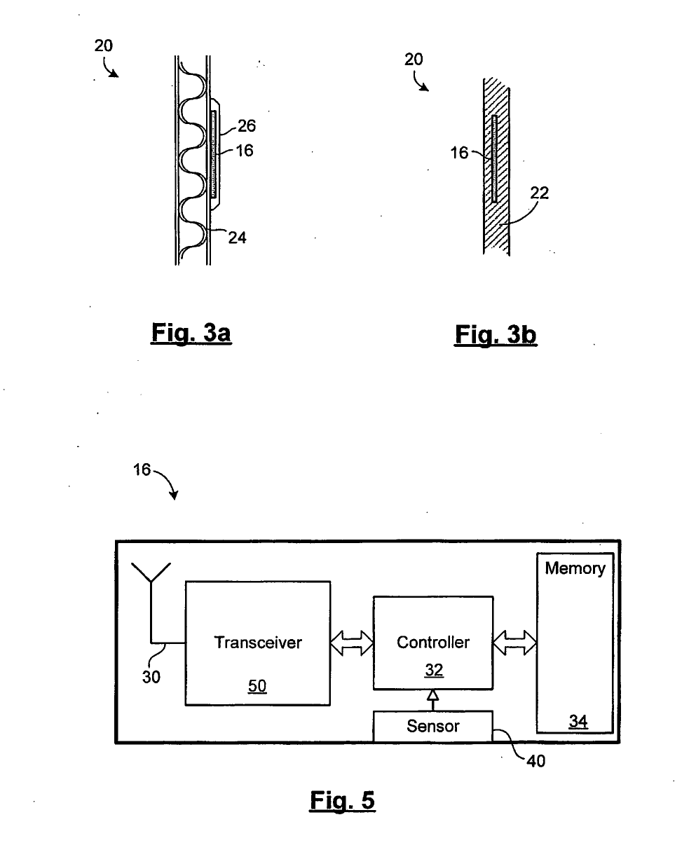

The integrity tag 16 may be attached to or embedded within the container 20. For example, in the case where the container 20 is a cardboard box, the integrity tag 16 may be embedded within a cardboard wall 24 of the box, or may be affixed to the interior or exterior of the container 20 using an adhesive or other attachment mechanism, as shown in FIG. 3(a). To prevent physical damage to the integrity tag 16, it may be embedded within a plastic casing 26 or other protective material, provided the material does not significantly degrade RF communications between the integrity tag 16 and the reader 12.

In some cases, the container 20 may be constructed of plastic or other moldable material. In such embodiments, the integrity tag 16 may be embedded within a wall 22 of the container 20 during the molding process, as shown in FIG. 3(b), provided the embedding may be performed without damaging the integrity tag 16 and/or significantly degrading RF communications between the integrity tag 16 and the reader 12.

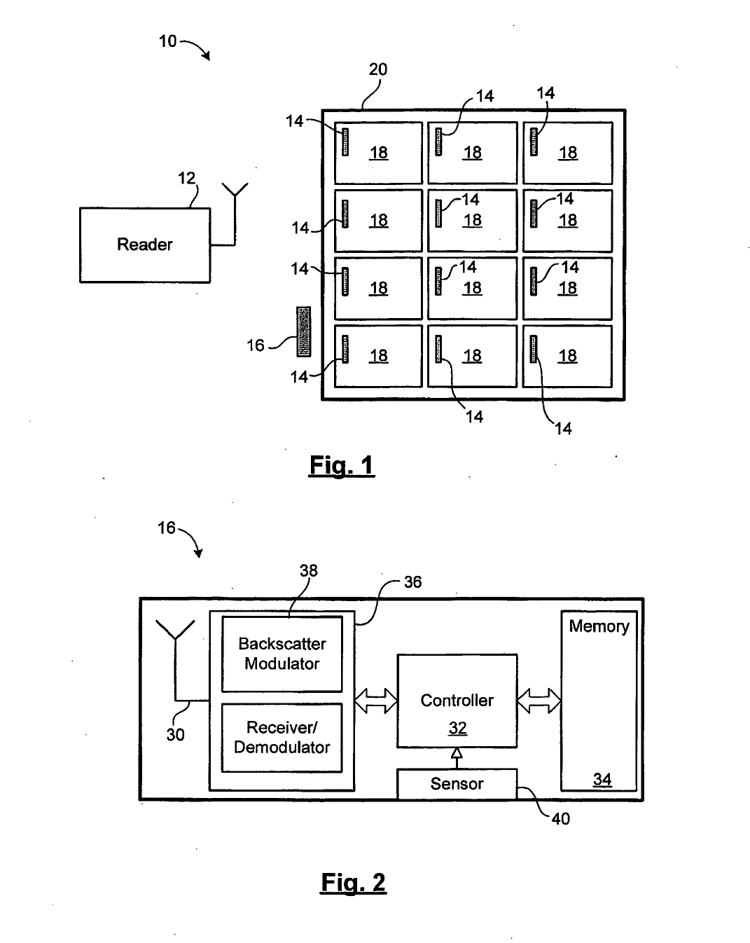

Reference is now made to FIG. 2, which shows a simplified block diagram of an embodiment of the integrity tag 16. In this embodiment, the integrity tag 16 comprises an RFID tag. In other embodiments, it may take other forms, such as a printed barcode or a contact memory.

The integrity tag 16 includes an antenna 30, a controller 32, a memory 34, and a communication module 36. The communication module 36 is coupled to the antenna 30 for receiving and demodulating incoming RF signals from the reader 12 (FIG. 1).

In a passive embodiment, the integrity tag 16 receives a continuous wave transmission from the reader 12 and the communication module 36 includes a backscatter modulation component 38. Operating under the control of the controller 32, the backscatter modulation component 38 switches between a reflective and absorptive characteristic to encode information into a reflected signal. The reflected signal propagates back to the reader 12.

In an active embodiment, the integrity tag 16 further includes a power sources, such as a battery (not shown), and the communication module 36 includes an active transmitter for generating a transmit signal encoded with information for propagation to the reader 12.

The various components and programming associated with conducting either passive or active RFID communications will be familiar to those of ordinary skill in the art.

In either embodiment, the memory 34 contains integrity information, such as, for example, an item count value or check sum. The controller 32 reads the integrity information and may update the integrity information if so instructed by the reader 12. When queried by a reader 12, the integrity tag 16 responds by transmitting the integrity information to the reader 12.

In one embodiment, the RFID communications between the integrity tag 16 and the reader 12 may use the same frequency and protocol as the communications between the item tags 14 and the reader 12. In another embodiment, a different frequency and/or protocol may be used.

In one embodiment, the integrity tag 16 includes a sensor device 40. The sensor device 40 generates sensor data in response to physical conditions proximate the integrity tag 16. The sensor data is stored by the integrity tag 16 in the memory 34, and may be sent to the reader 12 in response to an interrogation signal. The sensor data may assist the user in determining whether anyone has tampered with the container 20 (FIG. 1). The sensor device 40 may comprise a temperature sensor, a pressure sensor, or any other type of sensor for monitoring ambient physical conditions. For example, in a sealed container under vacuum or pressure a change in ambient pressure may indicate that the container has been damaged or opened. In another embodiment, the sensor device 40 may include a contact sensor that uses an electrical conductor to determine whether the package has been opened or tampered with. Other sensors will be understood by those skilled in the art.

In yet another embodiment, the integrity information stored in the memory 34 may be encrypted for security. In such an embodiment, the information is encrypted and then stored in the integrity tag 16. When interrogated by the reader 12, the integrity tag 16 transmits the encrypted integrity information. The reader 12 receives the encrypted integrity information and decrypts it to obtain the integrity information.

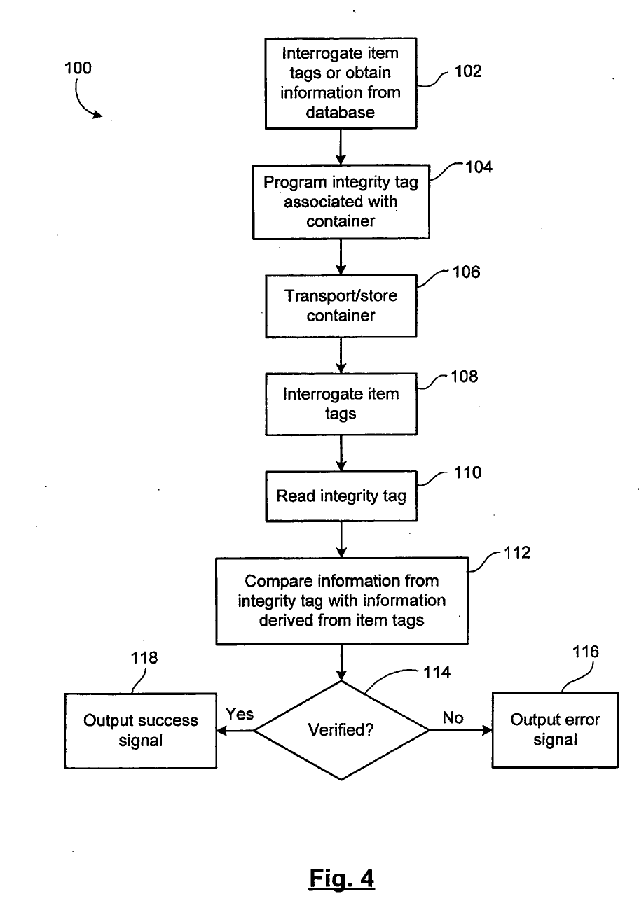

Reference is now made to FIG. 4, which shows, in flowchart form, a method 100 of tracking items in a container using an integrity tag. Each item is equipped with an item tag that stores item data in a memory element. In one embodiment, the item tag is a passive RFID tag that sends the item data to a reader using backscatter modulation of a continuous wave signal in response to a trigger or interrogation signal. A plurality of items, each having an item tag, are placed in or associated with a container.

The method 100 begins in step 102 wherein the plurality of item tags are interrogated by a reader. Based upon this interrogation, which may include multiple interrogate/read sequences, the reader obtains the item data from the item tags. The reader thereby derives integrity data. The integrity data may be based upon a count of the item tags, i.e. a count of the number of item tags that responded to the interrogation signals. The integrity data may include information derived from the item data, such as serial numbers, serial number ranges, product/manufacturer data, item tag address, or other details regarding the plurality of items and/or the item tags. In another embodiment, the reader may obtain item data and/or integrity data regarding the plurality of items or plurality of item tags from a database or other system.

In step 104, the reader transmits a programming signal to the integrity tag. The programming signal provides the integrity tag with integrity data, such as the count of item tags or a checksum value, and instructs the integrity tag to store the integrity data in its memory. In response to the programming signal, the integrity tag stores the integrity data in memory.

The container (or the plurality of items in general) is then stored, sealed, transported, or otherwise dealt with in the normal course of operations, as indicated in step 106.

At some later point, a user may wish to scan the container to read the item tags. The user may be the same person or a different person from the person that initiated steps 102-104. The container may be scanned upon arrival at a destination following shipping/transport. It may be scanned in connection with management of inventory in a warehouse facility, retail store, or other location. In any event, in step 108 a reader transmits an interrogation signal to interrogate the item tags associated with the container.

In response to the interrogation signal(s), the item tags provide the reader with a response signal containing item data. As before, the reader may determine the number of responses received in order to determine the number of item tags, and thus items, within the container. The reader may derive other information from the item tag responses, such as a list of serial numbers present in the container or other such information.

In step 110, the reader interrogates the integrity tag and receives a response signal from the integrity tag. The response from the integrity tag provides the reader with the integrity data.

In step 112, the reader compares the item data and information derived therefrom, with the integrity data obtained from the integrity tag. For example, the reader may compare a count value stored in the integrity tag with a count of the number of the item tags that responded to interrogations by the reader. In another example, the reader may compare a checksum against a value calculated from the item data.

Based upon the comparison, in step 114 the reader may verify the integrity of the item data, account for the presence of items, and/or determine if tampering occurred with the container. If the reader determines from the comparison that something is amiss, i.e. if there are item unaccounted for, if product information does not match up, or if sensor data indicates tampering, then the reader may output an alarm signal in step 116. Alternatively, if the comparison is successful, then the reader may output a success signal in step 118.

The output of the success signal in step 118 may, in an inventory processing system, trigger movement of the container to the next stage or processing. For example, the success signal may indicate that all the item tags, or at least a threshold number of the item tags, like 99%, have been successfully read and the container may therefore move to the next station in the inventory transportation system.

It will be appreciated that the reader may include a display, indicators, such as light emitting diodes, a speaker, and other user-interaction devices. The reader may display information obtained from the tags on a display and may display the results of any comparison tests or indicate any alarm conditions. The reader may use indicators or the speaker to signal an alarm condition or a successful comparison. Various alternatives for communicating such information to a user will be apparent to those of ordinary skill in the art.

It will be appreciated from the foregoing description that the described RFID inventory system may be employed to ensure the integrity of containers or collections of items and prevent loss or theft by determining if items are missing. This system will deter and detect most theft; however, sophisticated thieves may become aware of the presence of the integrity tag and may attempt to reprogram the integrity data in the tag, or replace the integrity tag, so as to conceal the removal of tagged items from the container. To prevent this from occurring, the integrity data may be encrypted and stored in the integrity tag as encrypted integrity data. Unauthorized individuals may be unable to surreptitiously reprogram the tags to alter the integrity data since they will be unable to obtain the correct encryption information.

In yet another embodiment, the integrity tag may be provided with an authorization certificate, i.e. a digital signature, when it is programmed with the integrity data. A reader 12 interrogating the integrity tag receives the authorization certificate and the integrity data (which itself may or may not be encrypted). The reader 12 may then authenticate the certificate through a public key infrastructure provider.

In one embodiment, the encryption may rely upon a shared secret key or algorithm. The integrity information may be stored in the integrity tag in encrypted form and is decrypted by the reader 12 when read. In other embodiments, the encryption may be based upon random seed values. Other methods and schemes of encryption will be familiar to those of ordinary skill in the art.

In another aspect, shown in FIG. 5, the integrity tag 16 may include a transceiver 50 to provide the integrity tag 16 with reader capabilities. In such an embodiment, the integrity tag 16 may function as a reader to interrogate the plurality of item tags 14 in the container 20. The integrity tag 16 may thereby obtain integrity information directly from the item tags 14 for storage in the memory 34. This embodiment renders it unnecessary to initially program the integrity tag with integrity information using a separate reader. It will be appreciated that the integrity tag 16 is an active device in such an embodiment.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A system for inventory control using radio frequency identification (RFID), the system being for tracking a plurality of items, the system comprising:
a plurality of item tags, each item tag being associated with one of the plurality of items and storing item information;
an integrity memory element associated with the plurality of items and storing information regarding said plurality of item tags; and
a reader for interrogating said plurality of item tags and for reading said integrity memory element, so as to permit verification of said item information.

2. The system claimed in claim 1, wherein a container is associated with the plurality of items and wherein said integrity memory element is associated with said container.

3. The system claimed in claim 2, wherein the container includes a container wall, and wherein said integrity memory element is embedded within said container wall.

4. The system claimed in claim 2, wherein the container includes a container wall, and wherein said integrity memory element is adhesively attached to said container wall.

5. The system claimed in claim 1, wherein said information regarding the plurality of item tags includes a count value for the number of item tags.

6. The system claimed in claim 1, wherein said information regarding the plurality of item tags includes an error detection or correction value.

7. The system claimed in claim 1, wherein said information regarding the plurality of item tags includes information regarding the number of item tags, and wherein said reader includes a verification module for comparing the number of item tags specified by said integrity memory element with a count of the number of said plurality of item tags responding to interrogation from the reader.

8. The system claimed in claim 7, wherein said verification module outputs an alarm signal in response to a mismatch in said comparison.

9. The system claimed in claim 1, wherein said information regarding said plurality of item tags is stored in said integrity memory element as encrypted data and said encrypted data is transmitted to said reader in response to an interrogation from said reader, and wherein said reader includes a decryption module for decrypting said encrypted data to obtain said information regarding said plurality of item tags.

10. The system claimed in claim 9, wherein said encrypted data includes a digital certificate.

11. The system claimed in claim 1, further including a transportation system, and wherein said reader outputs a success signal to the transportation system in response to verification of said item information, and wherein said transportation system moves the plurality of items to a next stage in response to said success signal.

12. The system claimed in claim 1, wherein said integrity memory element comprises an RFID integrity tag.

13. The system claimed in claim 12, wherein said RFID integrity tag further includes a reader component, said reader component including a transceiver for engaging in RF communications with said plurality of item tags, and wherein said RFID integrity tag obtains said information regarding said plurality of item tags directly from said plurality of item tags through said reader component.

14. The system claimed in claim 12, wherein said RFID integrity tag includes at least one sensor device, said sensor device providing sensor data, and wherein said RFID integrity tag stores said sensor data and provides said sensor data to said reader in response to an interrogation.

15. A container for holding a plurality of items, each of the items having an associated item tag, the tags being readable by a reader employing RFID communication, the container comprising:
sidewalls; and
an integrity tag, including an antenna, a controller, a modulator, and a memory, the memory storing integrity data for transmission to the reader in response to reception of an interrogation signal, the integrity data including data regarding the plurality of item tags.

16. The container claimed in claim 15, wherein said integrity tag further includes a protective casing housing said antenna, said controller, said modulator, and said memory, and wherein said protective casing is attached to one of said sidewalls.

17. The container claimed in claim 15, wherein said integrity tag is embedded within one of said sidewalls.

18. The container claimed in claim 17, wherein said one of said sidewalls is molded around said integrity tag in a molding process.

19. The container claimed in claim 15, wherein said integrity tag further includes a reader component, said reader component including a transceiver for engaging in RF communications with said plurality of item tags, and wherein said integrity tag obtains said data regarding said plurality of item tags directly from said plurality of item tags through said reader component.

20. The container claimed in claim 15, wherein said integrity tag includes at least one sensor device, said sensor device providing sensor data, and wherein said integrity tag stores said sensor data and provides said sensor data to said reader in response to said interrogation signal.

21. A method of verifying information regarding a plurality of items, each of the items having an associated item tag each storing item data, the plurality of items having an associated integrity memory element storing integrity data regarding the plurality of items, the method comprising the steps of:
interrogating the plurality of item tags using a reader;
receiving the item data from each item tag and reading the integrity data from the integrity memory element, wherein the integrity data includes a check value;
determining a variable based upon the item data received from the item tags; and
comparing the variable with the check value received from the integrity memory element to verify the integrity of the plurality of items.

22. The method claimed in claim 21, wherein said integrity memory element comprises an RFID integrity tag, and wherein said step of reading the integrity data comprises interrogating said RFID integrity tag and receiving a response signal containing the integrity data.

23. The method claimed in claim 21, wherein the check value includes a numerical count of the plurality of items, and wherein the variable comprises the number of item tags responding to said step of interrogating.

24. The method claimed in claim 21, wherein the check value includes a an error detection or correction value.

25. The method claimed in claim 21, further including a step of outputting an alarm signal if said comparison step detects a difference between the check value and the variable.

26. The method claimed in claim 21, further including first steps of reading the plurality of item tags, determining the check value based said step of reading, and programming the integrity memory element to store the integrity data, including the check value.

27. The method claimed in claim 26, further including a step of encrypting the integrity data prior to said step of programming, and further including a step of decrypting the integrity data following said step of reading.

28. The method claimed in claim 26, wherein said integrity data includes a certificate, said step of reading includes reading the certificate, and wherein the method further includes a step of authenticating the certificate following said step of reading.
